(19) United States
(12) Patent Application Publication
(10) Pub. No.: US 2021/0339721 A1
(43) Pub. Date: Nov. 4, 2021

(54) ARRANGEMENT AND METHOD FOR CONTROLLING WORKING BRAKES OF A HYDRAULICALLY OR ELECTRICALLY OPERATED WORK MACHINE

(71) Applicant: PONSSE OYJ, Vieremä (FI)

(72) Inventor: Markku SAVOLAINEN, Iisalmi (FI)

(21) Appl. No.: 17/271,805

(22) PCT Filed: Aug. 29, 2019
(86) PCT No.: PCT/FI2019/050616

§ 371 Date: Feb. 26, 2021

(30) Foreign Application Priority Data
Aug. 30, 2018 (FI) 20185719

(51) Int. Cl. B60T 8/24; B60T 8/18

(52) U.S. Cl. CPC B60T 8/245; B60T 2201/06; B60T 8/18

(57) ABSTRACT

This invention relates to off-road work machines and to controlling the brakes of an off-road work machine and particularly to an arrangement and a method for controlling the working brakes of a hydraulic or electric work machine. It is characteristic of a method according to the invention for controlling the brakes, preferably the working brakes, of a hydraulic or electric work machine (10), (50), in which the hydraulic or electric work machine (10), (50) comprises one or more frame parts (11), (12), (51), (52) and a moving means (13), (53) that the method comprises the steps of: detecting (31), (41) a driver's control action for starting the motion of the hydraulic or electric work machine (10), (50), keeping (32), (42) the brakes of the hydraulic or electric work machine (10), (50) applied and releasing (35), (45) the brakes of the hydraulic or electric work machine (10), (50) when said measured (33), (43) torque value exceeds a predetermined calculatory torque value.

### FIELD OF THE INVENTION

This invention relates to off-road work machines and to controlling the brakes of an off-road work machine and particularly to an arrangement and a method for controlling the working brakes of a hydraulic or electric work machine.

### BACKGROUND OF THE INVENTION

Work machines commonly utilised in off-road work machines are hydraulic or electric work machines. Hydraulic or electric work machines include, inter alia, forestry machines.

Forestry machines are used in mechanised harvesting for felling, delimbing, cutting to size, collecting, transporting and stacking trees. Forestry machines include e.g. harvesters, forwarders and their combinations, the so-called combined machines.

Forestry machines are off-road work machines which often have to work in quite uneven terrain. Particularly when working in a slope and further starting to move, there is a risk of the work machine starting to slide uncontrollably or racing downhill.

A traditionally used manner of controlling the working brakes of a forestry machine is to release the brakes simultaneously as starting to control the transmission components. When working in a slope and starting to move uphill, it is possible with the controlling manner according to prior-art technique that, when starting to move towards uphill, the forestry machine initially moves uncontrollably downhill before starting to move uphill. The phenomenon in question is due to the fact that the brakes are released before the transmission components are able to produce sufficient torque for the transmission to move the forestry machine towards uphill. Particularly when working in a steep slope with the help of a winch, this above phenomenon is very unfortunate and might at its worst lead to the damage of the cable.

In a similar way, when working in a slope and starting to move towards downhill, it is possible with the controlling manner according to prior-art technique that, when starting to move towards downhill, the forestry machine initially moves uncontrollably for a distance downhill before stabilising its move downhill.

One has tried to solve the problem in question with various arrangements according to prior art. One such a prior-art solution was presented in Finnish specification FI126906B which describes a calculatory time delay subsequent the start, after which time delay, the brakes of the work machine are released for the start. Said calculatory delay is still quite an inaccurate estimate of time and cannot in all situations prevent the forestry machine from sliding or racing downhill.

Indeed, there is a clear need for a solution which provides, inter alia, when working in a slope or uneven terrain when starting to move, a better than previously manner to prevent a hydraulic or electric work machine, such as a forestry machine, from uncontrollably sliding or rushing towards downhill.

### BRIEF DESCRIPTION OF THE INVENTION

The purpose of this invention is to provide a new arrangement for controlling the working brakes of a hydraulic or electric work machine, by means of which, it is better than previously possible to prevent the hydraulic or electric work machine from sliding uncontrollably or rushing towards downhill, and which minimizes the problems and disadvantages in the start of the hydraulic or electric work machine.

It is characteristic of an arrangement according to the invention for controlling the brakes, preferably the working brakes, of a hydraulic or electric work machine, in which the hydraulic or electric work machine comprises one or more frame parts and a moving means, which arrangement further comprises a control systems or measuring apparatus, that said measuring apparatus is arranged to measure a torque value from the transmission train of the hydraulic or electric work machine and, in which, said control system is arranged: to detect a driver's control action for starting the motion of the hydraulic or electric work machine, to keep the brakes of the hydraulic or electric work machine applied and to release the brakes of the hydraulic or electric work machine when said measured torque value exceeds a predetermined calculatory torque value.

Preferably in the arrangement, at least one of said one or more frame parts of the hydraulic or electric work machine is located on an inclined work base.

Preferably in the arrangement, said measuring apparatus is arranged to measure the inclination of the work base of the hydraulic or electric work machine in relation to the horizontal plane.

Preferably in the arrangement, said measuring apparatus is arranged to measure the position of the hydraulic or electric work machine or its tilt angle in relation to a gravitational vector.

Preferably in the arrangement, said calculatory torque value is defined based on the inclination of the slope and/or the weight of the hydraulic or electric work machine and/or the weight of the load of the hydraulic or electric work machine.

Preferably in the arrangement, said calculatory torque value is defined to correspond with the torque required to keep the hydraulic or electric work machine in place.

Preferably, said arrangement is arranged as the safety measure of the hydraulic or electric work machine.

Preferably in the arrangement, said hydraulic or electric work machine is a forestry machine.

It is characteristic of a method according to the invention for controlling the brakes, preferably the working brakes, of a hydraulic or electric work machine, in which the hydraulic or electric work machine comprises one or more frame parts and a moving means that the method comprises the steps of: detecting a driver's control action for starting the motion of the hydraulic or electric work machine, keeping the brakes of the hydraulic or electric work machine applied and releasing the brakes of the hydraulic or electric work machine when said measured torque value exceeds a predetermined calculatory torque value.

Preferably in the method, at least one of said one or more frame parts of the hydraulic or electric work machine is located on an inclined work base.

Preferably in the method, said measuring apparatus is arranged to measure the inclination of the work base of the hydraulic or electric work machine in relation to the horizontal plane.

Preferably in the method, said measuring apparatus is arranged to measure the position of the hydraulic or electric work machine or its tilt angle in relation to a gravitational vector.

Preferably in the method, said calculatory torque value is defined based on the inclination of the slope and/or the weight of the hydraulic or electric work machine and/or the weight of the load of the hydraulic or electric work machine.

Preferably in the method, said calculatory torque value is defined to correspond with the torque required to keep the hydraulic or electric work machine in place.

Preferably in the method, said hydraulic or electric work machine is a forestry machine.

### BRIEF DESCRIPTION OF THE DRAWINGS

Some embodiments of the invention will now be described in greater detail by means of some preferred embodiments, with reference to the attached drawings, in which

FIG. 1 shows a side view of a forestry machine according to an embodiment of the invention working on a slope uphill.

FIG. 2 shows a block diagram of the structure of a control arrangement of working brakes of a forestry machine according to an embodiment of the invention.

FIG. 3 shows a block diagram of a method according to an embodiment of the invention for controlling the working brakes of a forestry machine.

FIG. 4 shows a side view of a forestry machine according to an embodiment of the invention working on a slope downhill.

FIG. 5 shows a block diagram of a method according to an alternative embodiment of the invention for controlling the working brakes of a forestry machine.

FIG. 6 shows a side view of a forestry machine according to an alternative embodiment of the invention working on a slope uphill.

The figures are not to scale, and some features may have been simplified, emphasised or faded out to improve the clarity of the essential features of the figures.

### DETAILED DESCRIPTION OF THE INVENTION

The arrangement according to the invention utilizes as the aid of controlling the brakes, preferably working brakes, of a hydraulic or electric work machine a torque value measured from the transmission train such that the brakes are not released until the transmission components have provided sufficient torque for keeping the hydraulic or electric work machine in place. In the arrangement according to the invention, the hydraulic or electric work machine is preferably a forestry machine, such as a harvester or a forwarder.

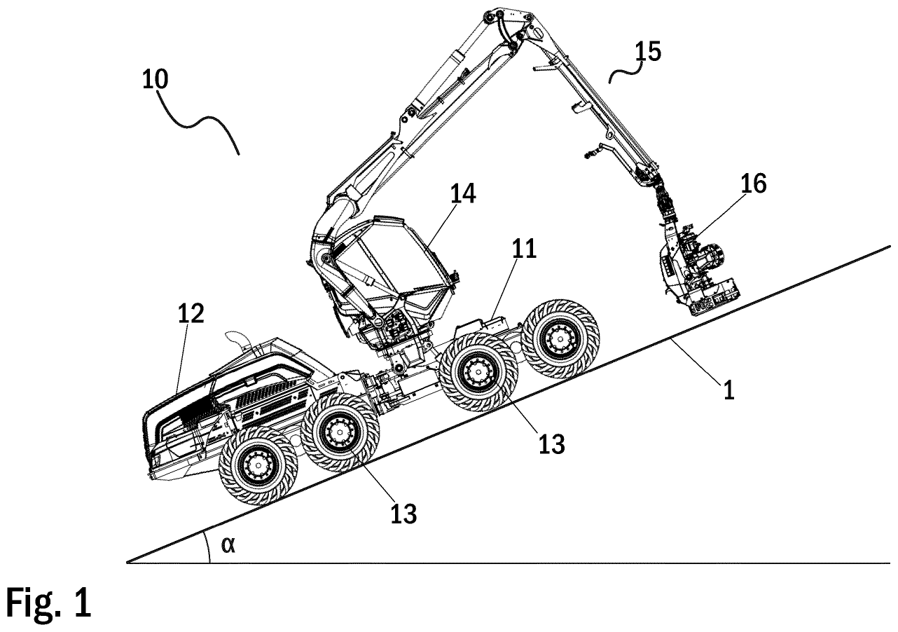

FIG. 1 shows a side view of a forestry machine according to an embodiment of the invention working on a slope uphill. FIG. 1 shows a forestry machine 10 according to an embodiment according to the invention, in more detail a harvester 10. The forestry machine 10 according to the invention is here shown on an inclined working base 1 which working base 1 is inclined upwards in the motion direction of the forest machine. In FIG. 1, inclination is designated by angle α. In different embodiments, the forestry machine 10 may also comprise another forestry machine, such as a forwarder or another drive machine suitable for carrying another type of load, a harvester, or a combination of a forwarder and harvester, or another forestry machine or another work machine moving on uneven terrain.

The forestry machine 10 according to the invention can comprise one or more frame parts 11, 12. The forestry machine 10 may further comprise a moving means 13, which moving means 13 may comprise at least one of the following: wheels arranged on an axle, wheels arranged on a swinging axle, wheels arranged on a tandem axle, a track system or another means known per se to cause the forest machine to move in relation to its working surface. The forestry machine 10 can additionally comprise a cabin 14 arranged at least to one frame part. It is obvious for those skilled in the art that typically the work machine additionally comprises numerous structural and functional components and entities that depend on the work machine type, such as a boom structure 15, a tool 16, a power source and so forth. The tool 16 may comprise a wood handling tool 16, such as a harvester head 16, and/or a lifting means, such as a load bucket.

The forestry machine 10 according to the invention can further comprise an arrangement for controlling the working brakes of the forestry machine. In this context, the working brakes refer to brakes which the forestry machine 10 can utilise when working on an inclined working base 1. Controlling the working brakes refers to in this context the controllable release of the working brakes e.g. in a situation in which one or more frame parts 11, 12 of the forestry machine is located on an inclined working base 1. By means of the control arrangement according to the invention of the forestry machine, it is possible to keep the brakes applied and to release them only when the forestry machine can be prevented from moving uncontrollably downhill by means of the transmission.

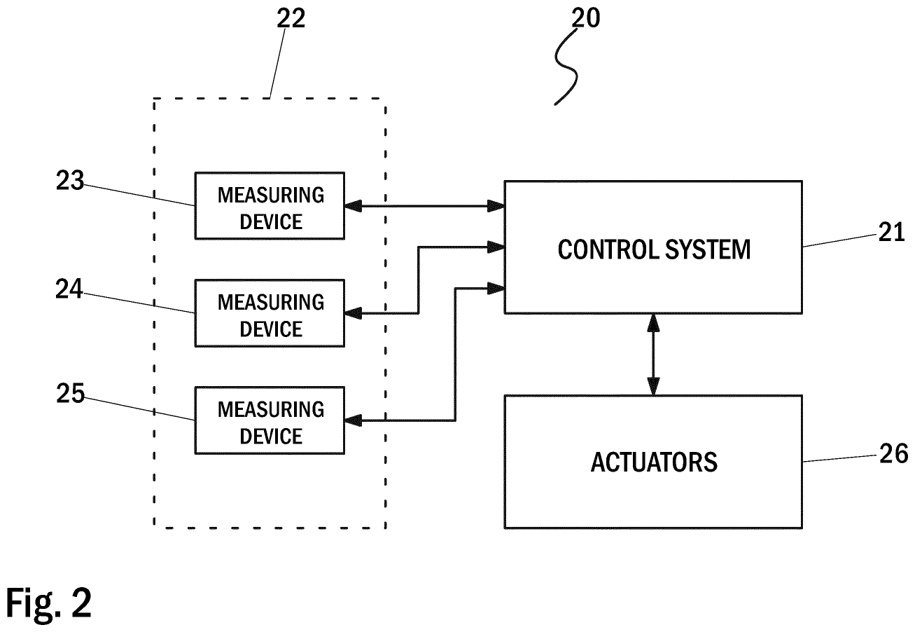

FIG. 2 shows a block diagram of the structure of a control arrangement of working brakes of a forestry machine according to an embodiment of the invention. The control arrangement 20 of the brakes of a forestry machine according to an embodiment of the invention 20 comprises a control system 21, a measuring apparatus 22 and actuators 26 of the forestry machine. The measuring apparatus 22 according to the invention of the control arrangement 20 can comprise at least two measuring devices 23-25, by means of which, it is possible to measure required measured variables, such as e.g. the inclination of the working base and the torque value of the transmission or the position or the tilt angle of the hydraulic or electric work machine in relation to the gravitational vector.

The at least two measuring devices 23-25 of the measuring apparatus 22 of the control arrangement 20 according to the invention can, in e.g. a hydraulic work machine or a CVT work machine (CVT, Continuously Variable Transmission), comprise pressure sensors 23-25. Correspondingly, the at least two measuring devices 23-25 of the measuring apparatus 22 of the control arrangement 20 according to the invention can, in e.g. an electric work machine, comprise electric current measuring sensors 23-25. Alternatively, the at least two measuring devices 23-25 of the measuring apparatus 22 of the control arrangement 20 according to the invention can comprise torque sensors 23-25 located in the mechanics of the hydraulic or electric work machine. Furthermore, the at least two measuring devices 23-25 of the measuring apparatus 22 of the control arrangement 20 according to the invention can comprise IMU sensor modules 23-25 (IMU, Inertia Measurement Unit) which IMU sensor modules 23-25 measure the position of the machine and/or the sensor module in relation to the gravitational vector. The measuring sensors of said IMU sensor modules 23-25 can be e,g. a 3D acceleration sensor and a 3D angular acceleration sensor. It is thus possible to discover from the machine position its tilt angle and from said tilt angle of the machine further the inclination of the working base.

The at least two measuring devices 23-25 of the measuring apparatus 22 of the control arrangement according to the invention of the working brakes of the forestry machine measure the torque value from the transmission of the forestry machine. Similarly, the at least two measuring devices 23-25 measure the inclination of the working base. Similarly, said at least two measuring devices 23-25 measure the position of the hydraulic or electric work machine or its tilt angle in relation to a gravitational vector. Said measured torque value is compared with the calculatory torque value which is required for keeping the forestry machine in place. Said calculatory torque value, i.e. the torque level on which the release of the working brakes is allowed, is determined based on e.g. the inclination of the slope and/or the weight of the forestry machine and/or the weight of the load of the forestry machine. By means of the control arrangement according to the invention of the forestry machine, it is possible to keep the brakes applied and to release them only when the forestry machine can be prevented from moving uncontrollably downhill by means of the transmission.

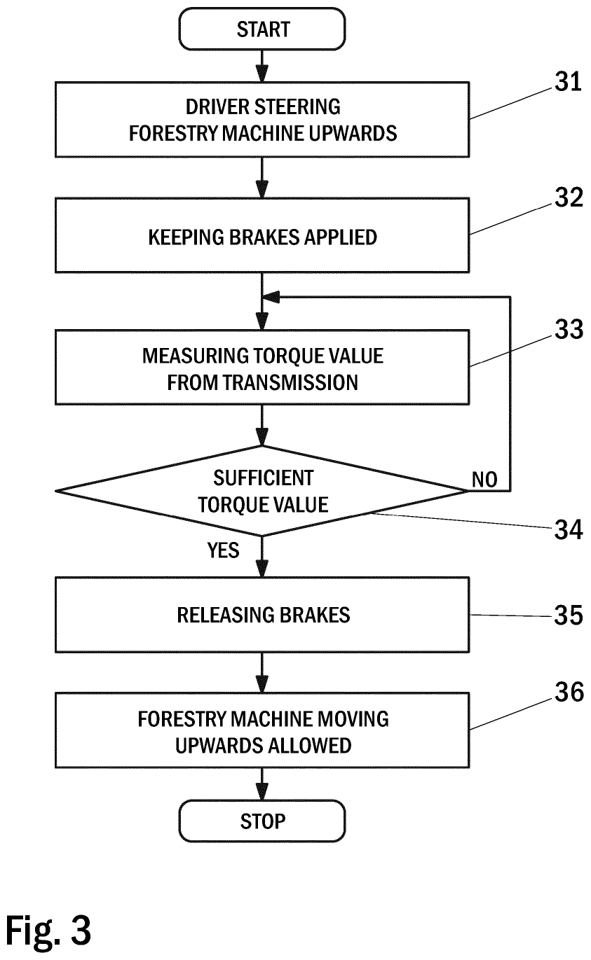

FIG. 3 shows a block diagram of a method according to an alternative embodiment of the invention for controlling the working brakes of a forestry machine. In a method according to an embodiment of the invention for controlling the working brakes of a forestry machine, first the driver of the forestry machine controls 31 the forestry machine to start moving upwards the slope in a situation in which the brakes of the forestry machine are applied. In the arrangement according to the invention, the control arrangement of the working brakes detects the driver's control action to start the moving of the forestry machine. The driver's said control action 31 can comprise e.g. releasing the brake pedal/switch and/or pressing the brake pedal. Next, the control arrangement of the working brakes keeps the brakes still applied 32. Furthermore next, a torque value is measured 33 from the transmission of the forestry machine. Said measured 33 torque value is compared 34 with the calculatory torque value which is required for keeping the forestry machine in place. The control system defines a calculatory torque value either already before the control arrangement of the working brakes detects a control action for starting the moving of the forestry machine or then in the step in which said control arrangement detects the control action for starting the moving of the forest machine.

If said measured 33 torque value is not sufficient for keeping the forestry machine in place, the control arrangement of the working brakes keeps the brakes still applied, repeats the measuring of the torque value 33 from the transmission of the forestry machine and further repeats the comparison of the thus measured 33 torque value 34 with said calculatory torque value. if said measured 33 torque value is sufficient for keeping the forestry machine in place, the control arrangement of the working brakes releases 35 the brakes. After having released the brakes 35, the forestry machine is allowed to move upwards 36.

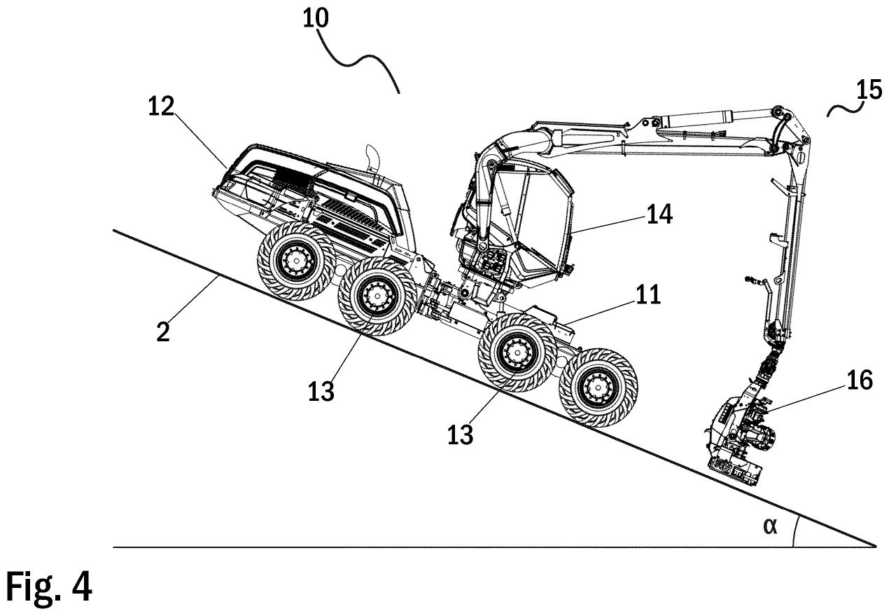

FIG. 4 shows a side view of a forestry machine according to an embodiment of the invention working on a slope downhill. FIG. 4 shows a forestry machine 10 according to an embodiment according to the invention, in more detail a harvester 10. The forestry machine 10 according to the invention is here shown on an inclined working base 2 which working base 2 is inclined downwards in the motion direction of the forestry machine. In FIG. 4, inclination is designated by angle α. In different embodiments, the forestry machine 10 may also comprise another forestry machine, such as a forwarder or another drive machine suitable for carrying another type of load, a harvester, or a combination of a forwarder and harvester, or another forestry machine or another work machine moving on uneven terrain.

The forestry machine 10 according to the invention can comprise one or more frame parts 11, 12. The forestry machine 10 may further comprise a moving means 13, which moving means 13 may comprise at least one of the following: wheels arranged on an axle, wheels arranged on a swinging axle, wheels arranged on a tandem axle, a track system or another means known per se to cause the forest machine to move in relation to its working surface. The forestry machine 10 can additionally comprise a cabin 14 arranged at least to one frame part. It is obvious for those skilled in the art that typically the work machine additionally comprises numerous structural and functional components and entities that depend on the work machine type, such as a boom structure 15, a tool 16, a power source and so forth. The tool 16 may comprise a wood handling tool 16, such as a harvester head 16, and/or a lifting means, such as a load bucket.

The forestry machine 10 according to the invention can further comprise an arrangement for controlling the working brakes of the forestry machine. In this context, the working brakes refer to brakes which the forestry machine 10 can utilise when working on an inclined working base 1. Controlling the working brakes refers to in this context the controllable release of the working brakes e.g. in a situation in which one or more frame parts 11, 12 of the forestry machine is located on a downwards inclined working base 2. By means of the control arrangement according to the invention of the forestry machine, it is possible to keep the brakes applied and to release them only when the forestry machine can be prevented from moving uncontrollably downhill by means of the transmission.

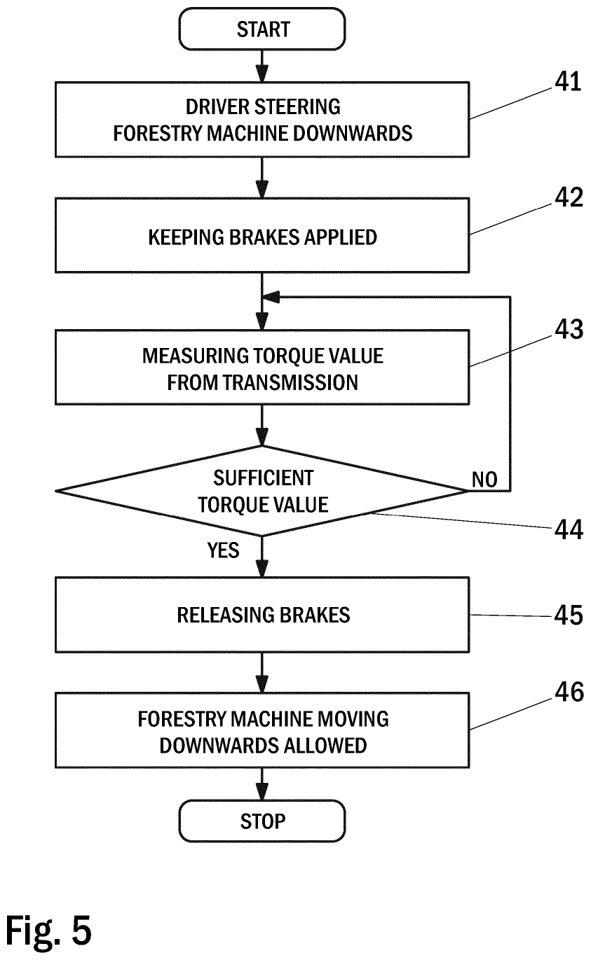

FIG. 5 shows a block diagram of a method according to an alternative embodiment of the invention for controlling the working brakes of a forestry machine. In a method according to an embodiment of the invention for controlling the working brakes of a forestry machine, first the driver of the forest machine controls 41 the forestry machine to start moving downwards the slope in a situation in which the brakes of the forestry machine are applied. The driver's said control action 41 can comprise e.g. releasing the brake pedal/switch and/or pressing the brake pedal. Next, the control arrangement of the working brakes keeps the brakes still applied 42. Furthermore next, a torque value is measured 43 from the transmission of the forestry machine. Said measured 43 torque value is compared 44 with the calculatory torque value which is required for keeping the forestry machine in place.

If said measured 43 torque value is not sufficient for keeping the forestry machine in place, the control arrangement of the working brakes keeps the brakes still applied, repeats the measuring of the torque value 43 from the transmission of the forestry machine and further repeats the comparison of the thus measured 43 torque value 44 with said calculatory torque value. If said measured 43 torque value is sufficient for keeping the forestry machine in place, the control arrangement of the working brakes releases 45 the brakes. After having released the brakes 45, the forestry machine is allowed to move downwards 46.

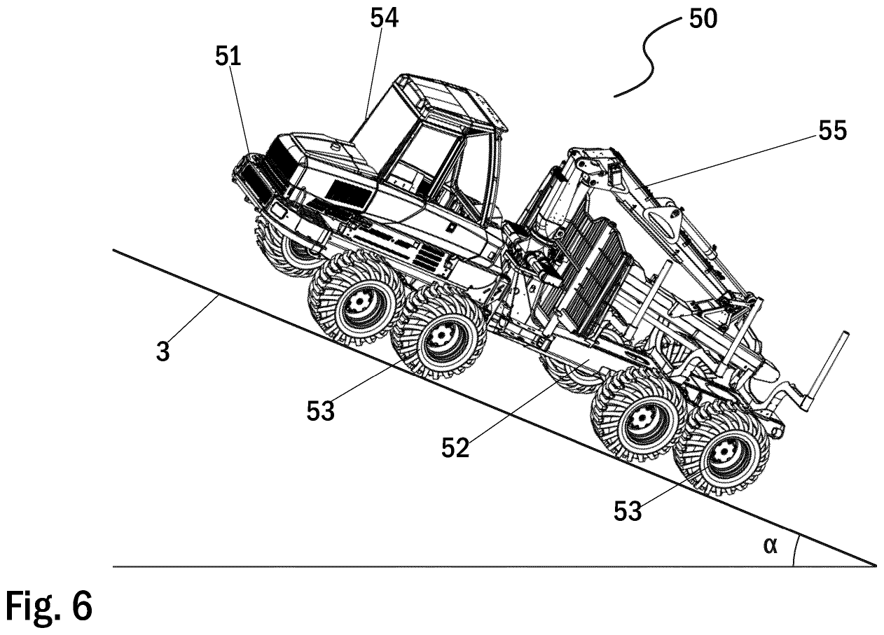

FIG. 6 shows a side view of a forestry machine according to an alternative embodiment of the invention working on a slope uphill. FIG. 6 shows a forestry machine 50 according to an embodiment according to the invention, in more detail a forwarder 50. The forestry machine 10 according to the invention is here shown on an inclined working base 3 which working base 3 is inclined upwards in the motion direction of the forestry machine. In FIG. 6, inclination is designated by angle α. The forestry machine 50 according to the invention can comprise one or more frame parts 51, 52. The forestry machine 10 may further comprise a moving means 53, which moving means 53 may comprise at least one of the following: wheels arranged on an axle, wheels arranged on a swinging axle, wheels arranged on a tandem axle, a track system or another means known per se to cause the forestry machine to move in relation to its working surface. The forestry machine 50 can additionally comprise a cabin 54 arranged at least to one frame part. It is obvious for those skilled in the art that typically the work machine additionally comprises numerous structural and functional components and entities that depend on the work machine type, such as a boom structure 55, a tool (not shown), a power source and so forth. The tool may comprise a hoisting member, such as a load bucket and/or a wood handling tool, such as a harvester head.

The forestry machine 50 according to an alternative embodiment of the invention can further comprise an arrangement for controlling the working brakes of the forestry machine. In this context, the working brakes refer to brakes which the forestry machine 50 can utilise when working on an inclined working base 3. Controlling the working brakes refers to in this context the controllable release of the working brakes e.g. in a situation in which one or more frame parts 51, 52 of the forestry machine is located on an inclined working base 3. By means of the control arrangement according to the invention of the forestry machine, it is possible to keep the brakes applied and to release them only when the forestry machine can be prevented from moving uncontrollably downhill by means of the transmission.

The idea according to the invention is to utilize as the aid of controlling the brakes, preferably working brakes, of a hydraulic or electric work machine a torque value measured from the transmission such that the brakes are not released until the transmission components have provided sufficient torque for keeping the hydraulic or electric work machine in place when starting to move uphill.

If there are hydraulic elements in the implementation of the transmission, the torque value can be deducted based on hydraulic pressure and, correspondingly, in electric drive train, the torque can be deducted based on electric current level etc. The torque level on which the release of the working brakes is allowed, is determined based on the inclination of the slope and/or the weight of the forestry machine and/or the weight of the load of the forestry machine.

The control principle according to the arrangement according to the invention can also be correspondingly utilized when starting to move in a steep slope towards downhill such that first the components of the transmission form a sufficient torque braking the motion of the forestry machine and then the brakes are released. Then, it is possible to prevent the momentary rushing of the forestry machine downhill when the brakes are released.

By means of the control principle according to the arrangement according to the invention, it is also possible to implement a separate safety application used when the hydraulic or electric work machine, such as a forestry machine, works on a slope, which said safety feature operates such that the working brakes are not released until the transmission components have been verified able to form a sufficient torque keeping the forestry machine in place. By means of said safety feature according to the invention, the transmission components can thus be tested before each start of moving and before the working brakes are released.

The above arrangements are particularly advantageous in connection with forestry machines carrying out work in uneven terrain, for example, harvesters, forwarders or their combinations, and this has a direct impact on the work ergonomics of the driver of the forestry machine.

Those skilled in the art will find it obvious that, as technology advances, the basic idea of the invention may be implemented in many different ways. The invention and its embodiments are thus not restricted to the above-described examples but may vary within the scope of the claims.

1-15. (canceled)

16. An arrangement on controlling brakes, preferably working brakes, of a hydraulic or electric work machine when working on a slope, in which the hydraulic or electric work machine comprises one or more frame parts and a moving means, which arrangement further comprises a control system and a measuring apparatus of the hydraulic or electric work machine in which:
said measuring apparatus is arranged to measure the torque value from the transmission of the hydraulic or electric work machine and in which:
said control system is arranged:
to measure the tilt angle of the hydraulic or electric work machine in relation to a gravitational vector,
to define a predetermined calculatory torque value based on the said tilt angle of the hydraulic or electric work machine and/or the weight of the hydraulic or electric work machine and/or the weight of the load of the hydraulic or electric work machine,
to detect a driver's control action for starting the moving of the hydraulic or electric work machine,
keeping the brakes of the hydraulic or electric work machine applied, and
releasing the brakes of the hydraulic or electric work machine when said measured torque value exceeds said predetermined calculatory torque value.

17. An arrangement according to claim 16, in which at least one of said one or more frame parts of the hydraulic or electric work machine is located on an inclined work base.

18. An arrangement according to claim 16, in which said measuring apparatus is arranged to measure the inclination of the work base of the hydraulic or electric work machine in relation to the horizontal plane.

19. An arrangement according to claim 16, in which said predetermined calculatory torque value is defined to correspond with the torque required to keep the hydraulic or electric work machine in place.

20. An arrangement according to claim 16, in which said arrangement is arranged as the safety measure of the hydraulic or electric work machine.

21. An arrangement according to claim 16, in which said hydraulic or electric work machine is a forestry machine.

22. A method for controlling brakes, preferably working brakes, of a hydraulic or electric work machine, in which the hydraulic or electric work machine comprises one or more frame parts and a moving means which method comprises the steps of:
measuring the tilt angle of the hydraulic or electric work machine in relation to a gravitational vector,
defining a predetermined calculatory torque value based on the said tilt angle of the hydraulic or electric work machine and/or the weight of the hydraulic or electric work machine and/or the weight of the load of the hydraulic or electric work machine,
detecting a driver's control action for starting the moving of the hydraulic or electric work machine,
keeping the brakes of the hydraulic or electric work machine applied,
measuring torque value from the transmission of the hydraulic or electric work machine, and
releasing the brakes of the hydraulic or electric work machine when said measured torque value exceeds said predetermined calculatory torque value.

23. A method according to claim 22, in which at least one of said one or more frame parts of the hydraulic or electric work machine is located on an inclined work base.

24. A method according to claim 22, the method further comprising a step of:
measuring inclination of the work base of the hydraulic or electric work machine in relation to the horizontal plane.

25. A method according to claim 22, in which said predetermined calculatory torque value is defined to correspond with the torque required to keep the hydraulic or electric work machine in place.

26. A method according to claim 22, in which said hydraulic or electric work machine is a forestry machine.
